(19) United States
(12) Patent Application Publication
(10) Pub. No.: US 2003/0035525 A1
(43) Pub. Date: Feb. 20, 2003

(54) System and method for distinguishing telephone number

(76) Inventors: Yang-Wei Wu, Taipei (TW); Chung-Chuan Chang, Hsin-Chuang (TW)

Correspondence Address: J.C. Patent, Inc., Suite 114, 1340 Reynolds Ave., Irvine, CA, 92614, US

(21) Appl. No.: 09/930,769

(22) Filed: Aug. 14, 2001

(51) Int. Cl. H04M 15/00; H04M 7/00

(52) U.S. Cl. 379/114.1; 379/221.02

(57) ABSTRACT

A system and a method for distinguishing a telephone number to distinguish telephone systems or network systems of various telephone companies. A telephone number is dialed. The telephone system or the network system of this telephone number is distinguished and selected. The telephone number distinguishing system has a plurality of receivers, a telephone dial processor, a plurality of selected switches and a communication connector device.

### BACKGROUND OF THE INVENTION

1. Field of the Invention

The invention relates in general to a system and a method for distinguishing a telephone number, and more particularly, to a system and a method to distinguish automatically the cheapest telephone rate.

2. Description of the Related Art

Due to the continuous progress of the communication field, a communication can be made via wired or wireless telephone or network telephone anytime and anywhere to reduce the connection time greatly. Wireless telephone companies have been established since the telephone system was opened to the public. The users can select a wired or wireless company as the communication medium according to factors such as the telephone rate.

The use of mobile phones is very common. To the users, a cheap telephone rate is desirous. Lately, the network telephone has also been developed as another optional communication method. However, the telephone rate for both wired and wireless is still currently very expensive. In particular, no discount is available when dialing from a commercial or domestic wired telephone to a mobile phone. Furthermore, medical research has reported that the electromagnetic waves generated by mobile phones causes damage to the human body in the long-term. In the future, as more wired telephone companies are established, the same problems as those of the wireless telephone network have to be confronted, namely, that different telephone rates result due to use of different wired telephone systems.

### SUMMARY OF THE INVENTION

The invention provides a system and a method for distinguishing a telephone number, and is applicable to both commercial and domestic telephones. This system and method automatically determines whether a wired telephone system, a wireless telephone system or a network telephone system is used to dial a number. As a result, a cheap telephone rate can be used.

The invention further provides a system and a method for distinguishing telephone numbers to replace wireless communication with wired telephones, such that the damage to human bodies caused by the electromagnetic wave generated by the mobile phones can be avoided.

The method provided by the invention is to distinguish the telephone systems or network systems of network telephones of various telephone companies. A telephone number is dialed. The telephone system or network system of such a telephone number is distinguished and automatically selected to dial the telephone number.

The telephone number distinguishing system can be coupled to several extensions and distinguishes the telephone system or network system provided by different telephone companies. A plurality of receivers is coupled to the extensions. The function selected analog signals and the telephone number analog signals output by the extensions are converted into function selected digital signals and telephone number digital signals, respectively. A telephone dial processor is coupled to the receivers to receive the function selected digital signals and execute the specified functions, and to receive the telephone number digital signals to select a telephone system or network system with a cheaper rate according to a lookup table. The telephone dial processor then outputs a selected signal. A plurality of selected switches is coupled to the telephone dial processor to receive the selected signal, and to put through a channel with respect to the selected signal. A telephone analog signal output from the extensions is thus transmitted. The system further comprises a telephone connector device coupled to the selected switches to transmit the telephone analog signal to the telephone system or network system of this channel.

Another telephone number distinguishing system can be connected to a telephone to distinguish the telephone system or network system belonging to various telephone companies. The system includes a receiver, a telephone dial processor, a selected switch and a communication connector device. The receiver is coupled to the telephone to convert a telephone number analog signal output from the telephone into a telephone number digital signal. The telephone dial processor is coupled to the receiver to receive the telephone number digital signal. The telephone dial processor further chooses a telephone system or a network system with a cheaper telephone rate according to a lookup table to output a selected signal. The selected switch is coupled to the telephone dial processor to receive the selected signal, and to connect the channel of the selected signal to transmit the communication analog signal output from the telephone. The communication connector device is coupled to the selected switch to transmit the communication analog signal to the telephone system or the network system corresponding to the channel.

The invention further provides a telephone number distinguishing system that can be connected to a telephone to identify a wired telephone system or network system of a network telephone for various telephone companies. The system comprises a receiver, a telephone dial processor, a selected switch and a communication connector device. The receiver is coupled to the telephone to convert a function selected analog signal and a telephone number analog signal into a function selected digital signal and a telephone number digital signal, respectively. The telephone dial processor is coupled to the receiver to receive the function selected digital signal to execute the specified function. The telephone dial processor further selects a wired telephone system or a network system with a cheap telephone rate according to a lookup table, and then outputs a selected signal. The selected switch is coupled to the telephone to receive the selected signal, and to connect a channel corresponding to the selected signal, so as to transmit a communication analog signal output from the telephone. The communication connector device is coupled to the selected switch to transmit the communication analog signal to the wired telephone system or the network system of the telephone company corresponding to the channel.

Both the foregoing general description and the following detailed description are exemplary and explanatory only and are not restrictive of the invention, as claimed.

### BRIEF DESCRIPTION OF THE DRAWINGS

FIG. 1 is a flow chart showing the method for distinguishing the telephone number according to the present invention;

FIG. 2 is a block diagram of a system for distinguishing the telephone number according to the present invention;

FIGS. 3 is a block diagram showing another telephone number distinguishing system according to the present invention; and

FIG. 4 is a block diagram showing yet another telephone number distinguishing system according to the present invention.

### DESCRIPTION OF THE PREFERRED EMBODIMENTS

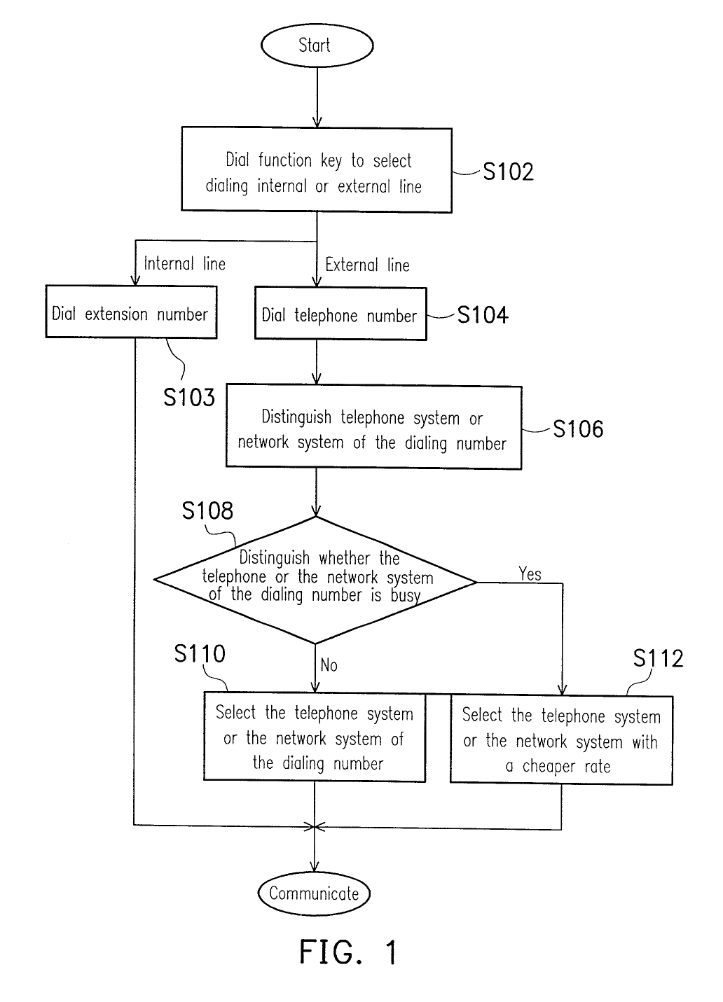

FIG. 1 shows the flow chart of the telephone number distinguishing method according to the invention. In FIG. 1, when the telephone number distinguishing system is used in a company telephone network, the user can select an internal line by directly dialing an extension number or an external line by selecting a function key on the telephone in step S102. For example, when a communication between the internal lines of the company is executed, the handset is picked up and the extension number is dialed directly for connection. When an external call is made, an external line function key (such as the 0 or 9 key) is selected and pushed. For a normal domestic telephone, the apparatus and steps for the internal line exchange are not required. Instead, an external line is always accessed directly.

In step S103, when selecting the internal line for internal connection in the company, the extension number of the receiving person is dialled. In step S104, when an external line is to be established, the telephone number of the receiving party is dialled. Meanwhile, the telephone number distinguishing system identifies the telephone system of this number, such that whether the telephone number belongs to a wired telephone system or a mobile call in a wireless telephone system can be distinguished. The telephone number may also belong to a network telephone. If this telephone number results in a wireless telephone call, the wireless telephone company of this telephone number has to be identified in step S106. At this point, a cheaper network telephone company or system can be used for this communication.

The telephone number distinguishing system checks whether the telephone system the receiving number is in use, thus causing the telephone line to be busy in step S108. When the line is not in use, the telephone number distinguishing system selects this telephone system to dial the telephone number, and to contact the receiving party in step S110. When the line is busy, the telephone number distinguishing system checks the telephone rate for various telephone companies to select the telephone company with a cheapest telephone rate, and dial the telephone number of this telephone company to contact the receiving party in step S112.

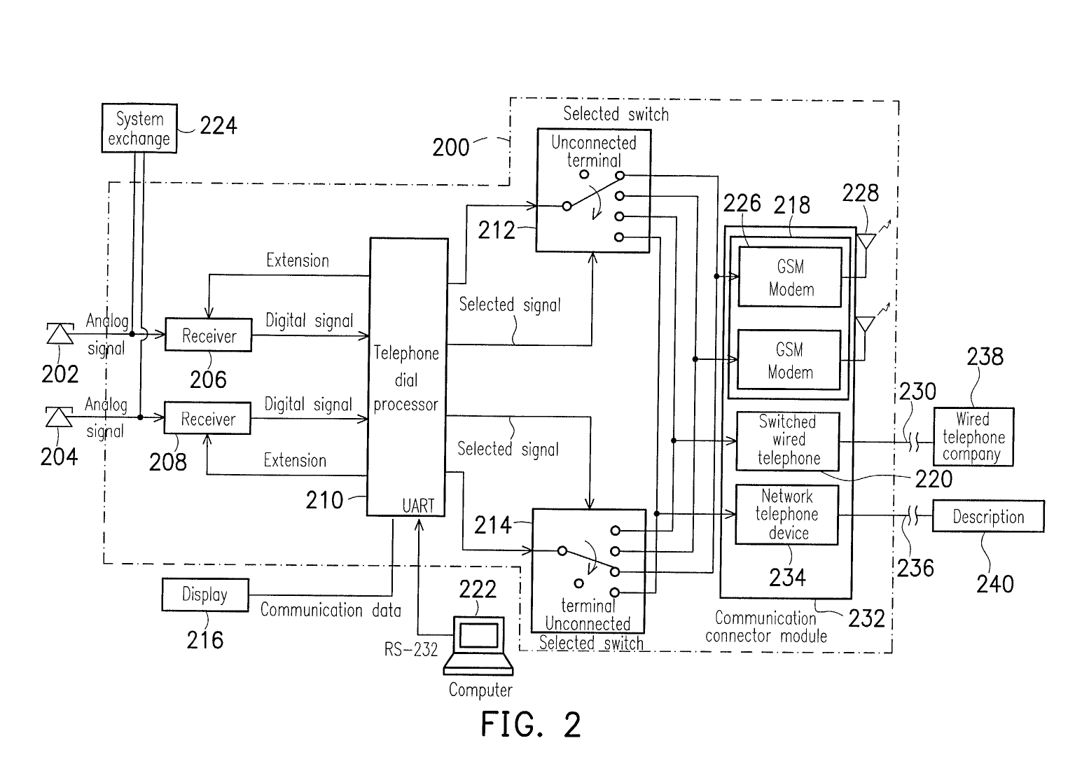

FIG. 2 shows a block diagram of the telephone number distinguishing system. In FIG. 2, the telephone number distinguishing system 200 is coupled to several extensions (two extensions are used as an example in this embodiment). The system is used to identify the telephone systems or network systems of various telephone companies. A power supply (not shown) of the telephone network system provides the power source to the telephone number distinguishing system 200. When an external line is to connect to an extension, such as the extension 202, the system exchange 224 puts through the extension 202. In FIG. 2, the structures of the telephone number distinguishing system 200 and the connection between the extensions and the external lines are shown.

In FIG. 2, the receivers 206 and 208 are coupled to the extensions 202 and 204, respectively. The function select analog signals and the telephone number analog signals output from the receivers 206 and 208 are converted into the function select digital signals and the telephone number digital signals, respectively.

The telephone dial processor 210 is coupled to the receivers 206 and 208 to receive the function select digital signals to execute the specified functions including selecting the extensions 202 for internal connection, or selecting an external line connection. When the internal connection is selected, the telephone dial processor 210 transmits the telephone number dialed by the extension 202 to the system exchange 224. Thus, via the system exchange 224, the extension 202 can connect other extensions. When an external line is to be connected, the telephone dial processor 210 receives a digital signal of the telephone number for the external line. According to lookup table of the telephone rates for various wired telephone companies 238, the wireless telephone companies or the network system of network telephone 240, a telephone system or network system with the cheapest rate is selected. The telephone dial processor 210 outputs a select signal corresponding to the telephone system or network system to selected switches 212 and 214. The lookup table of telephone rates stored in the telephone dial processor 210 stores the telephone rates of different time slots for different wired telephone companies, wireless telephone companies 238 or network systems 240. As the telephone rates for different wired telephone companies 238, the wireless telephone companies or network systems 240 fluctuate aperiodically, the telephone rate data in the lookup table is renewable. The data renewal of the lookup table can be performed via the universal asynchronous receiver/transmitter (UART). One of the methods for renewing the data includes downloading the latest telephone rates from various wired telephone companies 238, the wireless telephone companies or network systems 240. The computer 222 then transmits the renewal data to the UART port of the telephone dial processor 210 via the RS-232 of personal computers. After receiving the renewal data, the telephone dial processor 210 automatically renews the telephone rates of the lookup table. A display 216 can be set up at the operator. The telephone data output from the telephone dial processor 210 can be sent to the display 216 to show the time and cost of the telephone conversation.

The selected switches 212 and 214 are coupled to the telephone dial processor 210. If the extension 202 is to connect to an external line, the selected switch 212 is connected to the selected signal output from the telephone dial processor 210. The selected switch 212 then connects the channel corresponding to the selected signal. The telephone system or network system connected to this channel is the telephone system or the network system 240 that has the cheapest telephone rate. The channel transmits the analog signal of the telephone communication output from the extension 202 to the communication connector module 232. The communication connector module 232 comprises a GSM modem module 218, a switched wired telephone 220 and a network telephone device 234. If the extension 202 is not connected, the selected switch 212 configures the channel at a disconnected terminal according to the selected signal to avoid selecting the wrong telephone system or network system 240 when the extension 202 is connected. The increase of telephone bills is prevented. The function of the selected switch 214 is similar to that of the selected switch 212.

The communication connector module 232 with the GSM modem module 200, the switched wired telephone 220 and the network telephone device 234 is coupled to the selected switches 212 and 214. According to the channel of the selected switch 212 or 214, the GSM modem module 200, the switched wired telephone 220 and the network telephone device 234 are connected the telephone or network system 240 of the corresponding telephone company. For example, while ringing the wireless communication system of the wireless telephone company corresponding to the GSM modem 226, the telephone number belong to the GSM modem 226 is dialed. The receiving party is connected via the signal transmission of an antenna 228. If a wired communication system of a wired telephone company 238 is called, the telephone number of the wired telephone switch 220 is dialed. The connection is established via the cable to transmit or receive the signal. If the network system 240 is used to network the telephone, the cable 236 receives or transmits the signal from or to the network system 240. The number of the GSM modems of the GSM modem modules 200 can be adjusted according to the amount of telephone numbers used.

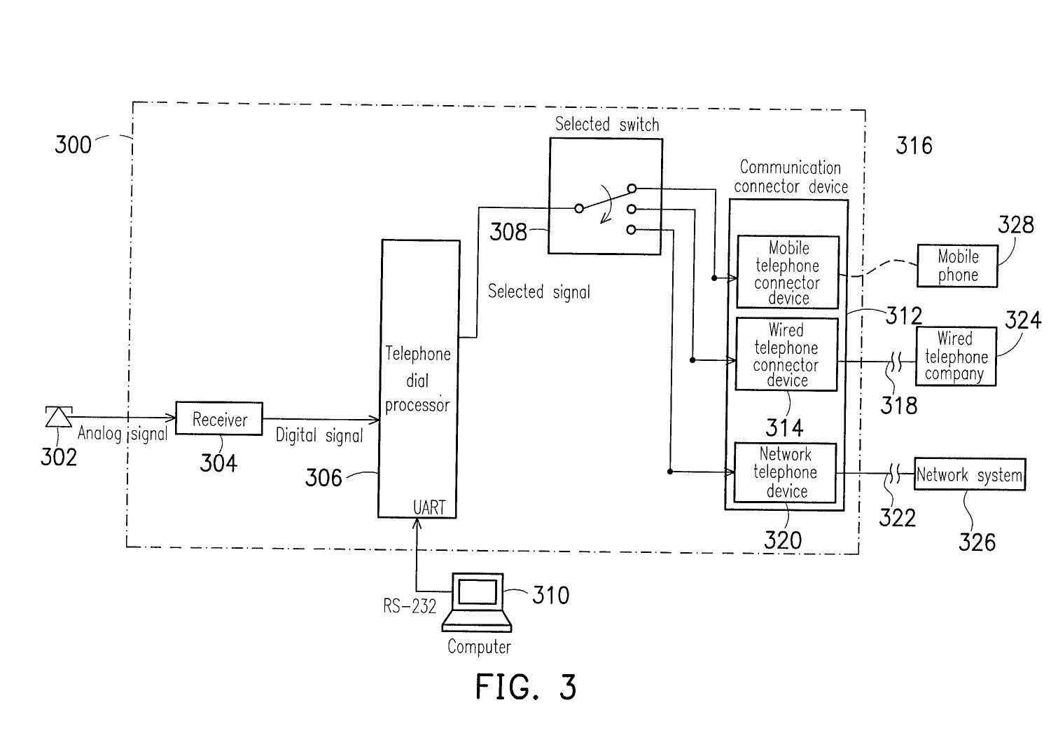

FIG. 3 shows a block diagram of another telephone number distinguishing system. As mobile phones are very commonly used, the telephone number distinguishing system used in a company can be applied to a domestic telephone system after some simple modification. In FIG. 3, the telephone number distinguishing system 300 is coupled to a telephone 302. The system is used to identify the telephone system or network system 326 of various telephone companies 324, wireless telephone companies 328 or network telephone companies. A power supply is used to provide power to the telephone number distinguishing system 300.

In FIG. 3, the receiver 304 is coupled to a telephone 302. The receiver 304 converts the telephone number analog signal output from the telephone 302 into a telephone number digital signal. When the telephone dial processor 306 receives the telephone number digital number, the telephone rates for the telephone communication between the telephone companies or the network system 326 stored in a lookup table are checked. The telephone system with the cheapest rate is selected. The telephone dial processor 306 then outputs a selected signal corresponding to the selected telephone system or network system 326 to a selected switch 308. The lookup table of the telephone dial processor 306 stores the telephone rates of various wired telephone company 324, the wireless telephone company or the network system 326. As the telephone rates fluctuate periodically, the data of lookup table is renewable. The data renewal of the lookup table can be performed via the universal asynchronous receiver/transmitter UART of the telephone dial processor 306. One of the methods for renewing the data includes downloading the latest telephone rates from various wired telephone companies 324, the wireless telephone companies or network systems 326 by a computer 310. The computer 310 then transmits the renewal data to the UART port of the telephone dial processor 306 via the RS-232 of personal computers. After receiving the renewal data, the telephone dial processor 306 automatically renews the telephone rates of the lookup table.

The selected switch 308 is coupled to the telephone dial processor 306. If the telephone 302 is to connect an external line, the selected switch receives a selected signal output from the telephone dial processor 306 and connects the channel corresponding to the selected signal. The telephone system or network system 326 connected to the channel is the telephone system or network system 326 with the cheapest telephone rate selected by the telephone dial processor 306. The channel further transmits the communication analog signal output from the telephone 302 to the communication connector device 312. If the telephone 302 is disconnected, the selected switch 308 configures the communication channel at the wired telephone connector device 314. When an external line is calling the telephone 302, the external line can be connected under a normal wired telephone communication mode.

The communication connector device 312 is coupled to the selected switch 312. The communication connector 312 comprises a mobile phone connector device 316, a wired telephone connector device 314 and a network telephone device 320. When a mobile phone (not shown) is plugged into the mobile phone connector device 316, the telephone 302 can connect to the external line via the mobile phone. According to the channel of the selected switch 308, the communication connector device 312 connects the telephone system or network system 326 of the corresponding telephone company. For example, when the wireless communication system of the wireless telephone company is to be connected, the mobile phone plugged in the mobile phone connector device 316 is connected, and the receiving party is connected via the signal transmitted and received by the mobile phone. If a wired communication system of the wired telephone company 324 is to be called, the wired telephone connector device 314 is connected, and the receiving party is connected by transmitting and receiving signal via the cable 318. If the network system of the network telephone is to be used, the telephone number of the network telephone device 320 is dialed. By sending signal via the cable 322, the receiving party is connected.

When the amount of the domestic telephone numbers is increased, the number of the receivers and selected switches is increased consequently. As a result, the number of the mobile phones used domestically is also increased. The number of the mobile phone connector devices 316 plugged in the communication connector device 312 is also increased. Thus, the expansion of the telephone number distinguishing system is very flexible. That is, the system can be expanded according to the specific requirements of the users.

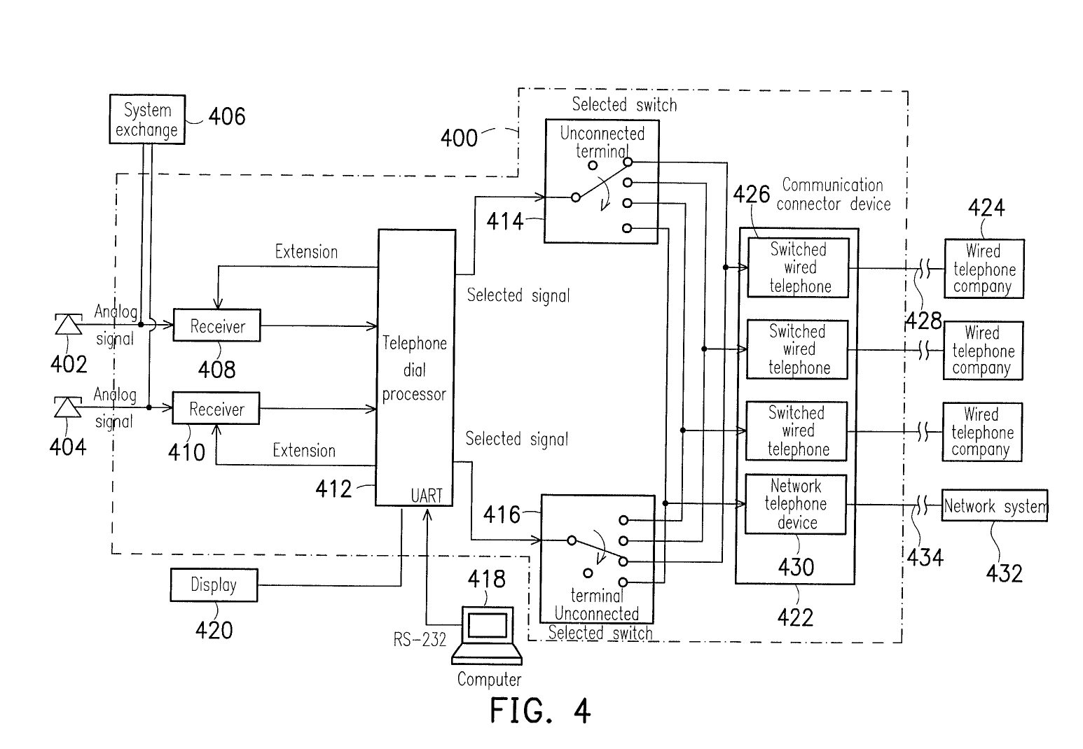

FIG. 4 shows another embodiment of the telephone number distinguishing system. Since the telephone system was opened to public, many wired telephone companies have been established, all having different telephone rates. The telephone number distinguishing system is thus suitable for distinguishing between various wired telephone companies and network system 432 of network telephone. In FIG. 4, a company telephone network is used as an example. The telephone number distinguishing system 400 can be connected to several extensions (two extensions are used as an example in this embodiment). The system is used to distinguish between the telephone system of different wired telephone companies 424 and the network system 432 of different network telephones. A power supply is used to provide the power to the telephone number distinguishing system 400. When an external line is calling an extension (for example, the extension 402) of the company, the system exchange 406 connects the extension 402 directly. In FIG. 4, only the system structures for the telephone number distinguishing system 400 and the external connections for the extensions are illustrated and described.

In FIG. 4, the receivers 408 and 410 are coupled to the extensions 402 and 404, respectively. The function select analog signals and the telephone number analog signals output from the receivers 402 and 404 are converted into the function select digital signals and the telephone number digital signals, respectively.

The telephone dial processor 412 is coupled to the receivers 408 and 410 to receive the function select digital signals to execute the specified functions including selecting the extensions for internal connection, or selecting an external line connection. When the internal connection is selected, the telephone dial processor 412 transmits the telephone number dialed by the extension 402 to the receiver 408. The receiver 408 then transmits the dialed number to the system exchange 406. Thus, via the system exchange 406, the extension 402 can connect other extensions. When an external line is to be connected, the telephone dial processor 412 receives a digital signal of the telephone number for the external line. A telephone system or network system with the cheapest rate is selected according to a lookup table of the telephone rates for various wired telephone companies, the wireless telephone companies and the network system of network telephone 432. The telephone dial processor 412 outputs a select signal corresponding to the telephone system or network system to selected switches 414 and 416. The lookup table of telephone rates stored in the telephone dial processor 412 stores the telephone rates of different time slots for different wired telephone companies, wireless telephone companies or network systems 432. As the telephone rates for different wired telephone companies, the wireless telephone companies or network systems 432 fluctuate aperiodically, the telephone rate data in the lookup table is renewable. The data renewal of the lookup table can be performed via the universal asynchronous receiver/transmitter UART. One of the methods for renewing the data includes downloading the latest telephone rates from various wired telephone companies, the wireless telephone companies or network systems 432. The computer 418 then transmits the renewal data to the UART port of the telephone dial processor 412 via the RS-232. After receiving the renewal data, the telephone dial processor 412 automatically renews the telephone rates of the lookup table. A display 420 can be set up at the operator. The telephone data output from the telephone dial processor 412 can be sent to the display 420 to show the time and cost of the telephone conversation.

The selected switches 414 and 416 are coupled to the telephone dial processor 412. If the extension 402 is to connect an external line, the selected switch 414 is connected to the selected signal output from the telephone dial processor 412. The selected switch 414 then connects the channel corresponding to such selected signal. The telephone system or network system connected to this channel is the telephone system or the network system 432 that has the cheapest telephone rate. The channel transmits the analog signal of the telephone communication output from the extension 402 to the communication connector module 422. If the extension 402 is hang up, the selected switch 414 will go back to the unconnected terminal automatically according to the selected signal to avoid selecting the wrong telephone system or network system when the extension 402 pick up the phone. The increase of telephone bills is prevented. The function of the selected switch 416 is similar to that of the selected switch 414.

The communication connector module 422 comprising several wired telephone exchanges (such as wired telephone 426) and the network telephone devices 430 is coupled to the selected switches 414 and 416. According to the channel of the selected switch 414 or 416, the telephone system or network system of the corresponding wired telephone company is connected. For example, when the wired telephone company 424 is to be dialed, the switched wired telephone 426 of the wired telephone connector module 422 is connected. By receiving or transmitting signals via the cable 428, the receiving party is connected. If the network system 432 is to be called, the network telephone device 430 of the wired telephone connector module 422 is connected. By receiving or transmitting signals via the cable 434, the receiving party is connected. The wired telephone exchanges in the wired telephone connector module 422 can be expanded arbitrarily. The amount of such telephone exchanges increases in response to the number of telephone numbers used.

The telephone number distinguishing system 400 as shown in FIG. 4 is suitable for a normal domestic telephone. The amount of the receivers and selected switches is the same as the amount of the telephone numbers. The wired telephone exchange of the wired telephone connector module 426 is replaced with a wired telephone connector device, which has the same amount as the telephone numbers. The telephone number distinguishing system 400 can be expanded by the user according to specific requirements.

Thus, for both company and domestic telephones, which telephone system or network system is to be used for making a telephone call can be determined automatically. The user can obtain a cheaper telephone rate.

Another advantage of the invention is that the system can be expanded with great flexibility according to the specific requirements demanded by the user.

A further advantage of the invention is that the mobile phone can be replaced by the wired telephone to prevent damaging the human body by the electromagnetic waves generated by the mobile phone.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A method for distinguishing a telephone number from a telephone system of a plurality of telephone companies or a network system of a network telephone, the method comprising:
dialing a telephone number;
identifying the telephone system or network system which the telephone number belongs to; and
selecting the telephone system or network system to connect the telephone number.

2. The method according to claim 1, further comprising selecting a function key to establish an external line before performing dialing the telephone number.

3. The method according to claim 1, wherein if the line is busy when dialing the telephone line, a telephone system or network system with a cheapest telephone rate in a lookup table is selected for dialing.

4. A telephone number distinguishing system, connected to a plurality of extensions to distinguish a telephone system from a plurality of telephone companies or a network system of a network telephone, the telephone number distinguishing system comprising:
a plurality of receivers, coupled to the extensions to convert a function select analog signal and a telephone number analog signal output from the extensions into a function select digital signal and a telephone number digital signal;
a telephone dial processor, coupled to the receivers to receive the function select digital signal to execute a specified function and the telephone number digital signal, to select the telephone system or the network system with a cheapest telephone rate according to a lookup table, and to output a selected signal;
a plurality of selected switches, coupled to the telephone dial processor to receive the selected signal, to connect a channel corresponding to the selected signal, and to transmit a communication analog signal output from the extensions; and
a communication connector module, coupled to the selected switches to transmit the communication analog signal to the telephone system or the network system corresponding to the channel.

5. The telephone number distinguishing system according to claim 4, wherein telephone rate data in the lookup table of the telephone dial processor is renewable.

6. The telephone number distinguishing system according to claim 4, wherein the telephone dial processor displays time and cost for communication via a display.

7. The telephone number distinguishing system according to claim 4, further comprising:
a GSM modem module, coupled to the selected switches to transmit the communication analog signal to a corresponding wireless telephone system according to the channel;
a wired telephone exchange, coupled to the selected switches, to transmit the communication analog signal to the corresponding wired telephone system according to the channel; and
a network telephone device, coupled to the selected switches, to connect the network system via the network dial up to establish a telephone communication via the network telephone.

8. The telephone number distinguishing system according to claim 1, wherein the GSM modem modules comprises at least one GSM modem.

9. The telephone number distinguishing system according to claim 1, comprising further a power supply to provide power to the telephone number distinguishing system.

10. A telephone number distinguishing system, connected to a telephone for distinguish a telephone system of a plurality of telephone companies or a network system of a network telephone, comprising:
a receiver, coupled to the telephone to convert a telephone number analog signal into a telephone number digital signal;
a telephone dial processor, coupled to the receiver to receive the telephone number digital signal and to generate a selected signal by selecting a telephone system or a network system with a cheapest telephone rate according to a lookup table;
a selected switch, coupled to the telephone to receive the selected signal, and to connect a channel corresponding to the selected signal to transmit a communication analog signal output from the telephone; and
a communication connector device, coupled to the selected switch to transmit the communication analog signal to the telephone system or the network system of the telephone company corresponding to the channel.

11. The telephone number distinguishing system according to claim 10, wherein telephone rate data of the lookup table of the telephone dial processor is renewable.

12. The telephone number distinguishing system according to claim 10, wherein telephone communication time and cost are displayed by a display.

13. The telephone number distinguishing system according to claim 10, wherein the communication connector device comprises a wired telephone connector device and a mobile phone connector device, and a mobile phone is plugged into the mobile phone connector device.

14. The telephone number distinguishing system according to claim 10, wherein the communication connector device further comprises a network telephone device to establish a telephone connection by the network telephone via the network system.

15. The telephone number distinguishing system according to claim 10, further comprises a power supply to provide power to the telephone number distinguishing system.

16. A telephone number distinguishing system, connected to a telephone to distinguish a telephone system of a plurality of telephone companies or a network system of a network telephone, the telephone number distinguishing system comprising:
a receiver, coupled to the telephone to convert a function select analog signal and a telephone number analog signal output from the telephone into a function select digital signal and a telephone number digital signal;
a telephone dial processor, coupled to the receiver to receive the function select digital signal to execute a specified function and the telephone number digital signal, and to select a telephone system or a network system with a cheapest telephone rate according to a lookup table, and to output a selected signal;
a selected switch, coupled to the telephone dial processor to receive the selected signal, to connect a channel corresponding to the selected signal, and to transmit a communication analog signal output from the telephone; and
a communication connector device, coupled to the selected switch to transmit the communication analog signal to the telephone system or the network system corresponding to the channel.

17. The telephone number distinguishing system according to claim 16, wherein telephone rate data in the lookup table of the telephone dial processor is renewable.

18. The telephone number distinguishing system according to claim 16, wherein the telephone dial processor displays time and cost for communication via a display.

19. The telephone number distinguishing system according to claim 16, wherein the communication connector device comprises either a plurality of wired telephone connector devices or a plurality of wireless telephone exchanges.

20. The telephone number distinguishing system according to claim 16, wherein the communication connector device further comprises a network telephone device to establish a telephone connection by the network telephone via the network system.

21. The telephone number distinguishing system according to claim 16, further comprising a power supply to provide power to the telephone number distinguishing system.
